(19) United States
(12) Patent Application Publication
(10) Pub. No.: US 2004/0236957 A1
(43) Pub. Date: Nov. 25, 2004

(54) Method for managing purchase of broadcast digital contents and means for downloading same

(76) Inventors: Alain Durand, Rennes (FR); Christophe Laurent, Vignoc (FR)

Correspondence Address: Joseph S Tripoli, Thomson Licensing Inc, Patent Department, PO Box 5312, Princeton, NJ, 08543-5312, US

(21) Appl. No.: 10/484,901

(22) PCT Filed: Jul. 24, 2002
(86) PCT No.: PCT/FR02/02641

(30) Foreign Application Priority Data
Jul. 27, 2001 (FR) 01/10085

(51) Int. Cl. H04L 9/00

(52) U.S. Cl. 713/193; 380/44

(57) ABSTRACT

The invention concerns a method for managing purchase of digital contents comprising steps which consist in: at a terminal level, a) receiving a digital content broadcast by broadcasting means; b) generating a content purchase order; c) transmitting the purchase order to means for processing the order; d) downloading the content from the processing means. The method further comprises, between steps c) and d) a content payment step at the end of which the terminal receives from the processing means a downloading ticket containing data used by the terminal for downloading the content at step d).

### FIELD OF THE INVENTION

The present invention concerns a method for managing the purchase of digital contents.

The invention is implemented in an installation of the type comprising means for broadcasting digital contents, at least one remote terminal suitable for receiving the broadcast content and means for storing the digital contents linked to the broadcasting means.

### BACKGROUND ART

Usually such an installation also comprises a call center that a user of the terminal can contact if, during the broadcast by the broadcasting means of a digital content, he wishes to order said content. Such an installation also comprises a purchasing center to which the user is directed by the call center after the latter has supplied him with commercial information on the broadcast digital content.

However, this installation does not allow the user to send simply and impulsively an order for the broadcast digital content.

The document FR-A-2 795 540 describes a method for acquiring audio video or textual sequences from a remote site using a local terminal according to which the terminal receives remote broadcast signals containing the sequence data and broadcast sequence identification data, the latter data being able to be transmitted, in an acquisition request produced by the terminal user, to the remote site to acquire the sequence. When the remote site receives this request, it transmits the sequence data to the user's terminal. It is also specified in this document that access authorization data and/or data for decrypting the sequence data be transmitted by the remote site to the terminal when certain conditions are fulfilled.

Nevertheless, the fact of transmitting the ordered data sequence before even having carried out the checks on validity of the payment or on authorization of access by the user may present certain risks because the user may attempt to procure data sequences fraudulently.

### SUMMARY OF THE INVENTION

The invention aims to overcome this disadvantage by proposing a method for managing purchase of content enabling the user to send simply and impulsively an order for a digital content he wishes to acquire, particularly during its broadcast, while preventing the user from being able to access the content before having paid for it.

The subject of the invention is therefore a method for managing purchase of digital contents comprising the steps consisting for a terminal in: a) receiving a digital content broadcast by broadcasting means; b) generating a purchase order for the content; c) transmitting the purchase order to means for processing the order; and d) downloading the content from said processing means. As claimed in the invention, the method also comprises, between steps c) and d), a step of payment for the content after which the terminal receives from said processing means a download ticket, said download ticket containing information used by the terminal to download the content in step d).

So the digital content purchase management method as claimed in the invention ensures that the user does not receive the ordered content until after a (successful) payment step. Another advantage of this purchase management method is that it enables impulse buying of broadcast digital contents by the unit, such as a song instead of a complete album. The invention also advantageously enables avoidance of unnecessary downloads which may dangerously load a download server included in the processing means. In effect, a user will more easily tend to request a data download if he does not have to pay immediately whereas if, as in the invention, the download does not take place until after the payment step, the user will download only the contents he really wishes to acquire.

The digital content purchase management method as claimed in the invention may also comprise one or more of the following characteristics:

the processing means comprise means for downloading the digital content and the download ticket comprises a seed to generate, with the aid of a pseudo-random generator using it as input variable, a pseudo-random key, this key being used by the download means to encrypt the digital content in the downloading step d);

the download ticket comprises the URL universal address of the download means;

the download ticket is transmitted to the terminal in a form encrypted with the aid of a secret symmetrical key;

the payment step is implemented by the terminal communicating with financial transaction management means to which is transmitted the purchase order and which deliver the download ticket received by the terminal;

the terminal also receives from the financial transaction management means a transaction identifier;

the terminal transmits to the download means a proof of payment before step d); and

the proof of payment contains said transaction identifier received from the financial transaction management means and an authentication message;

the download step d) comprises a step of dividing the digital content into a plurality of successive digital sub-contents and of encoding each of these digital sub-contents, followed by a step of downloading these digital sub-contents in succession to the terminal;

each encoded digital sub-content, with the exception of the last, comprises the corresponding digital sub-content and the value of a hash function applied to the subsequent encoded digital sub-content; and

the download step comprises a step for generating a message comprising the number of digital sub-contents and the value of the hash function applied to the first encoded digital sub-content, this message being authenticated with the aid of a symmetrical secret key known only to the order processing means and the terminal.

The invention also concerns means for downloading digital contents via a data transmission network, characterized in that they comprise means for receiving a proof of payment of an order to purchase a broadcast digital content and means for transmitting this digital content to a terminal sending the proof of payment.

The download means as claimed in the invention can also comprise one or more of the following characteristics:

they are suitable for transmitting the digital content in a form encrypted with the aid of a pseudo-random key generated with the aid of a seed, this seed having been previously received by the terminal sending the proof of payment in a download ticket after the payment step;

they comprise means for dividing the digital content into a plurality of successive digital sub-contents, means for encoding each of these digital sub-contents and means for successive transmission of these digital sub-contents;

each encoded digital sub-content, with the exception of the last, comprises a corresponding digital sub-content and the value of a hash function applied to the subsequent digital sub-content; and

the download means comprise means for generating a message comprising the number of digital sub-contents and the value of the hash function applied to the first encoded digital sub-content.

### BRIEF DESCRIPTION OF THE DRAWINGS

The invention will be better understood on reading the following description, given only as an example and made with reference to the attached drawings in which:

FIG. 1 represents schematically a digital content purchase management installation in which the invention is implemented;

FIG. 2 represents the steps of a method as claimed in the invention implemented in the installation of FIG. 1, as claimed in a first mode of embodiment; and

FIG. 3 represents a part of the steps of a method as claimed in the invention implemented in the installation of FIG. 1, as claimed in a second mode of embodiment.

### DETAILED DESCRIPTION OF EMBODIMENTS OF THE INVENTION

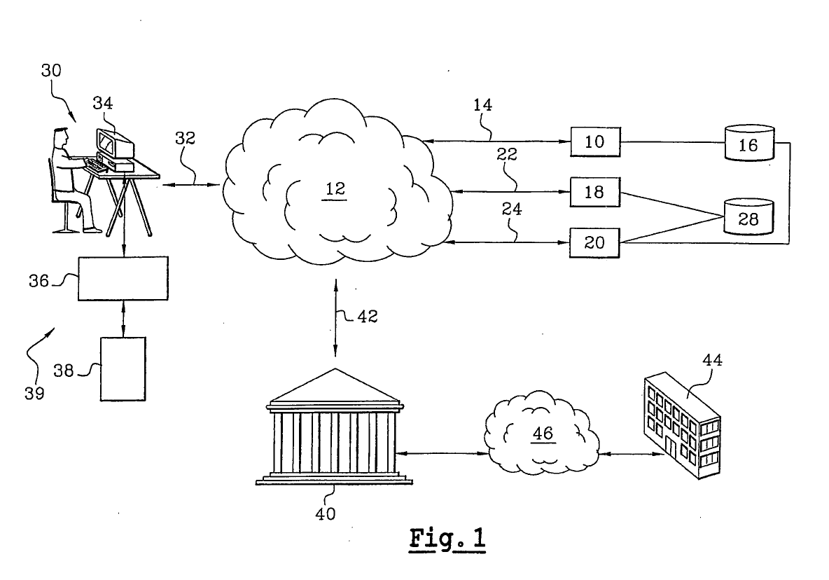

The digital content purchase management installation represented in FIG. 1 comprises broadcasting means 10 linked to a data transmission network 12 such as the Internet, by means of a conventional bidirectional communication link 14. The broadcasting means 10 are as an example an Internet radio comprising a server of conventional type linked to means 16 of storing digital content accessible in read-only mode by the server 10.

The installation also comprises a financial transaction management module 18 that can send and receive information relating to orders for digital contents and a module 20 for the downloading of purchased digital contents via the Internet network 12. These modules are also, for example, servers of conventional type linked to the Internet network 12 by conventional bidirectional communication links 22 and 24.

The broadcasting server 10, the management server 18 and the download server 20 are independent and, in this example, are located on different sites. It is also possible as a variant for the broadcasting server 10, management server 18 and download server 20 to be located on the same site or be implemented by a single physical server. In another variant, the management server 18 and the download server 20 are located on a site (or embodied in the form of a single server) independent of the broadcasting server 10.

The management server 18 and the download server 20 are linked to means 28 for storing orders. They can be accessed in read-only mode by the download server 20 and in write mode by the transaction management server 18.

The means 16 for storing digital content can also be accessed in read-only mode by the download server 20.

The installation also comprises at least one remote terminal 30 connected to the Internet network 12, by means of a bidirectional link 32. This remote terminal 30 comprises a display screen 34, suitable for presenting the digital contents broadcast by the broadcasting server 10. The remote terminal 30 is also authorized to exchange data with the transaction management server 18 and the download server 20.

Finally, the remote terminal 30 comprises a micropayment module (not shown) implementing a method of micropayment and is associated with a reader 36 of conventional type, into which one can insert a smart card 38, forming an electronic purse. This smart card comprises a unique serial number C₁ for identifying a user of the remote terminal 30, the owner of this card, while preserving his anonymity. The micropayment module, the reader 36 and the electronic purse 38, constitute conventional micropayment means 39.

The micropayment method implemented by the micropayment module installed on the remote terminal 30 is also implemented by the transaction management server 18.

The installation also comprises a payment token distribution server 40, forming means for electronic micropayment management, connected likewise to the Internet network 12 by means of a bidirectional link 42. This payment token distribution server 40 is linked to a financial institution 44 via a secure private network 46.

The payment token distribution server 40 is suitable for delivering payment tokens to the remote terminal 30, these subsequently being stored in the electronic purse 38 via the micropayment means 39. The payment token distribution server 40 is also suitable for retrieving payment tokens collected, particularly from the electronic purse 38, by the transaction management module 18. Such a token distribution server 40 is known and will not be detailed further.

It also implements the micropayment method implemented by the remote terminal 30 and the transaction management server 18.

In the context of this micropayment method of conventional type, the token distribution server 40 holds a first proof of payment secret key K₁.

This first secret key K₁ is a key known as the master key which is also held by the transaction management server 18 and by the download server 20. These latter receive it in a secure manner without using the Internet network 12, after identifying themselves for the first time to the token distribution server 40. It is then stored by the transaction management server 18 and by the download server 20 in a secure manner.

In addition, the smart card forming the electronic purse 38 contains a symmetrical encryption derived secret key M₂, obtained from the proof of payment master key K₁ and from the serial number C₁ of the smart card forming the electronic purse 38. This symmetrical encryption derived secret key M₂ is given by the following formula:

M₂=Df(K₁, C₁),

Where Df is a conventional key derivation function such as the HMAC-SHA1 function.

This symmetrical encryption derived secret key M₂ is stored in the memory of the smart card 38 at the time of its manufacture.

The micropayment method used is for example that described in French patent application No. 00 08867, dated Jul. 7, 2000, filed in the name of THOMSON MULTIMEDIA and bearing the title “Systême et procédé de gestion de transactions de micro-paiement, terminal de client et équipement de marchand correspondants”.

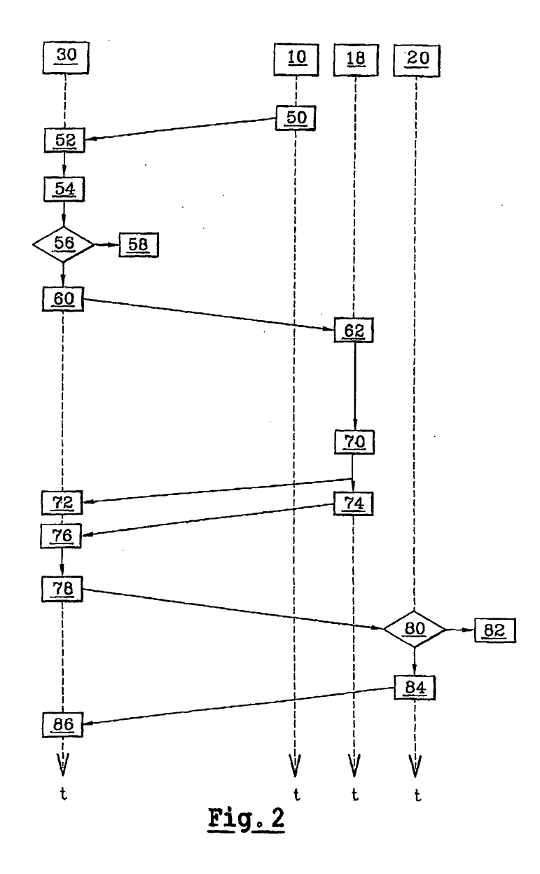

In FIG. 2 as claimed in a first mode of embodiment are shown the steps of a digital content purchase management method implemented in the previously described installation, between the terminal 30 and the broadcasting server 10, management server 18 and download server 20.

In a first step 50, the broadcasting server 10 sends, as claimed in pre-established programming, a digital content extracted from the digital content storage means 16.

This broadcast digital content is for example an audio file F encoded as claimed in the MP3 standard containing for example a song or a piece of music. The MP3 standard authorizes the insertion of commercial information into the broadcast audio file by means of a label complying with the ID3v2 standard. In conventional manner, this label necessarily comprises information concerning the price of the broadcast digital content (for example the price of the broadcast song) and the universal address URL of the seller of this digital content. The label may also comprise information concerning the date on which the price of the digital content ceases to be valid, the means for delivering the content after purchase, the name of the seller, a textual description of the digital content, an image representing the seller's logo, or any other information recommended by the ID3v2 standard.

The digital content is broadcast by the broadcasting server 10 via the Internet network 12 for the attention of subscribers or users connected to the network.

In particular, the user of the remote terminal 30 receives this broadcast digital content by means of a presentation interface, obtained for example by the execution of a Java applet, downloaded previously from the broadcasting server 10.

While the digital content is being broadcast (or immediately after its broadcasting), in a step 52, the user of the remote terminal 30 activates the generation of an order form to order the broadcast content, by simply clicking the mouse on an active button of the interface. This activation causes the presentation on the display screen 34 of an order form comprising at least a part of the information contained in the previously described label and received by the remote terminal 30 at the same time as the broadcast digital content.

In the subsequent step 54, the user confirms his order in conventional manner after having read the proposed order form.

The terminal 30 then transmits the information concerning the price of the ordered digital content to the micropayment means 39 which checks, during a test step 56, that the electronic purse 38 comprises sufficient tokens to make the purchase. It is assumed that each token represents a predetermined value and that the price of the digital content corresponds to a given number of tokens.

If the electronic purse does not comprise sufficient tokens, we move on to step 58 which stops the order. Otherwise, we move on to step 60 for transmitting the confirmed order form.

During this step 60, the micropayment means 39 debit the electronic purse 38 with a number C₂ of tokens corresponding to the price indicated on the label.

The terminal 30 then transmits to the transaction management server 18, via the Internet network 12, a firm purchase order C comprising at least a part of the commercial information relating to the digital content purchased, such as, for example, a description C₃ enabling identification of this content, the serial number C₁ of the electronic purse 38 and the number C₂ of tokens extracted from this electronic purse 38. The description C₃ is for example the title of the ordered song.

Secure transmission of this firm purchase order is provided for in conventional manner by the micropayment method implemented by the remote terminal 30.

In the next step 62, the transaction management server 18 receives the firm purchase order C. It then generates in step 64 a transaction identification number M₁ associated in unique manner with this purchase order C.

In this same step, the transaction management server 18 orders the creation, in the order storage means 28, of a file corresponding to this order C and comprising the transaction identification number M₁, the serial number C₁ of the electronic purse 38 and the description C₃ of the digital content purchased. In this file are also kept micropayment parameters M₃ comprising for example the price of the transaction, the transaction identification number M₁, etc. A copy of these parameters M₃ is also kept by the micropayment means 39.

Then, in a step 70, the transaction management server 18 transmits the transaction identification number M₁ to the remote terminal 30.

The identification number M₁ is received and stored by the remote terminal 30 in a step 72.

Furthermore, following step 70 also, the transaction management server 18 generates a download ticket T during a step 74.

This download ticket T comprises the URL universal address T₁ of the download server 20 and a seed T₂, generated by the transaction management server 18, which will be used subsequently by the download server 20. The seed T₂ is also stored in the order storage means 28, in the abovementioned file corresponding to the order C.

For added security, this download ticket T is encrypted with the aid of a second symmetrical secret key K₂ generated by the transaction management server 18 from the derived secret key M₂ and the micropayment parameters M₃.

In effect, the transaction management server 18 is capable of retrieving the derived secret key M₂ from the master secret key K₁ and from the serial number C₁ which was transmitted to it in step 62.

The second symmetrical secret key K₂ is obtained with the aid of the previously defined derivation function Df, so that:

K₂=Df(M₂, M₃).

Which gives the following formula, for T:

T=E_{K}_{₂}(T₁|T₂),

where the symbol “|” designates the concatenation of data.

It will be noted that K₂ can also be obtained with the aid of a derivation function Df′ different from Df.

In the subsequent reception step 76, the terminal 30 receives the encrypted download ticket. It is capable of generating the second symmetrical secret key K₂ also, from the derived secret key M₂, from the micropayment parameters M₃ received in step 72 and from the function Df. It is therefore the only terminal capable of decrypting the download ticket T transmitted by the transaction management server 18.

In the subsequent step 78, the terminal 30 sends a message P requesting the download of the purchased digital content to the download server 20. This message P forming proof of payment comprises the transaction identification number M₁, the description C₃ of the purchased digital content and the serial number C₁ of the smart card 38. It is authenticated by an authentication message P₄ contained in the message P. This authentication message P₄ is calculated by applying to the abovementioned data contained in the proof of payment P a conventional MAC hash function, using the derived secret key M₂. The result of this is that:

P₄=MAC_{M}_{₂}(M₁|C₁|C₃) and P=(M₁|C₁|C₃|P₄).

This proof of payment P is received by the download server 20 in a test step 80. In this step 80, the download server 20 verifies the authenticity of the authentication message P₄ with the aid of the derived secret key M₂ which it retrieves from the secret key K₁ and from the serial number C₁ contained in the proof of payment P, to verify that the data contained in the message P₄ do indeed correspond to the transaction identification number M₁, to the description C₃ of the digital content purchased and to the serial number C₁ of the smart card 38.

If the verification is unsuccessful, we move on to step 82 to cancel the download, because the download server 20 then has proof that the message received does not come from the purchaser of the digital content.

On the other hand, if the verification is successful, it proves that the remote terminal 30 possesses the derived secret key M₂ and is therefore the purchaser of the digital content. We then move on to a step 84 for the downloading this digital content. For this, the download server 20 accesses the means 16 for storing digital content and copies a file F′ corresponding to the digital content purchased. This file may be identical to the file F broadcast by the broadcasting server 10, but may also be of a different nature. In effect, even if F and F′ must comprise the same multimedia content, the quality levels required for the broadcast file F and the downloaded file F′ are not necessarily the same.

To transmit in a secure manner this file F′, the download server 20 generates a pseudo-random key K₃ of the same size as the file F′ to be transmitted. The pseudo-random key K₃ is generated with the aid of a pseudo-random generator using as input variable the seed T₂ generated by the transaction management server 18 in step 74. This seed T₂ is fetched by the download server 20 from the means 28 for storing the order with the aid of the information contained in the proof of payment P. The download server 20 combines the pseudo-random key K₃ with the file to be transmitted F′ with the aid of a mixer of XOR type, to form a ciphering file F₃=K₃ XOR F′.

This ciphering file F₃ is transmitted to the terminal 30 with the aid of a download protocol ensuring an integrity of the downloaded content.

Finally, in a last step 86, the terminal 30 receives the ciphered file and, like the download server 20, generates the pseudo-random key K₃ from the seed T₂ that it received in step 76 and from the pseudo-random generator. It then deduces from this the file F′ comprising the purchased digital content, by the following formula:

F′=F₃ XOR K₃.

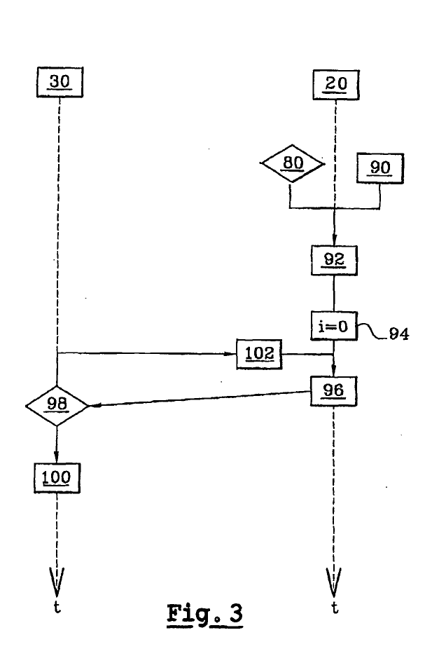

FIG. 3 partially represents the steps of a purchase management method as claimed in a second mode of embodiment. This purchase management method is implemented in the installation described in FIG. 1, between the terminal 30 and the download server 20.

This purchase management method comprises the same steps 50 to 82 as the method described previously. These are therefore not shown in FIG. 3, with the exception of step 80, and will not be described.

This method comprises an encoding step 90 that can be carried out by the download server 20 at any time since it does not depend on parameters linked with terminal 30. In this step, the download server 20 divides the file F′ into n sub-files F′ᵢ (1≦i≦n) from which it generates n sub-files Sᵢ (1≦i≦n).

The sub-files Sᵢ are calculated in the following manner:

Sₙ=(F′ₙ|H(F′ₙ)),

Sᵢ=(F′ᵢ|H(Sᵢ₊₁)), for 1≦i≦n−1.

In these equations, H represents a conventional one-way hash function.

In a step 92 following the test step 80, if the verification of the signature P₄ of the proof of payment has been successful, the download server 20 generates a sub-file S₀ given by the following formula:

S₀=(H(S₁)|n|MAC_{M2}(H(S₁)|n)).

So instead of transmitting the file F′ in a single transmission, the download server 20 transmits in succession the sub-files Sᵢ, for i lying between 0 and n, to the remote terminal 30.

To do this, we move on to a step 94, during which the download server 20 sets a counter i to 0.

During the subsequent step 96, the download server 20 transmits the sub-file Sᵢ to the remote terminal 30.

Then, in a test step 98, the remote terminal 30 verifies the integrity of the received sub-file Sᵢ.

If the index i equals 0, the remote terminal 30 verifies that the signature of the sub-file S₀ corresponds to the data contained in this sub-file, that is to say the number n and the value of H (S₁). Thereafter, the terminal 30 knows the number n of sub-files that it should receive from the download server 20 following the sub-file S₀ and the hash value of the next sub-file S₁ to be received.

If the index i lies between 1 and n−1, on receipt of the sub-file Sᵢ, the terminal 30 applies the hash function H to this sub-file to verify that its hash value does indeed correspond to that which the terminal 30 received in the previous reception step. Again, the terminal 30 stores in memory the hash value of the subsequent sub-file Sᵢ₊₁.

If the index i equals n, the terminal 30 verifies the integrity of the sub-file Sₙ received, by applying as previously the hash function H to this sub-file Sₙ, to verify that it does indeed correspond to the value it stored in the previous step. Then, if the verification is successful, the remote terminal 30 stores F′ₙ in memory.

In this test step 98, if the verification is unsuccessful or if the index i equals n, we move on to step 100 to stop the download.

On the other hand, if the verification is successful and if i is strictly less than n, we move on to step 102 during which the remote terminal 30 stores F′ᵢ in memory and the index i is incremented by one unit. We then resume the method at step 96 of transmission.

At the end of this method, the remote terminal 30 has stored in memory all the files F′ᵢ and can thus reconstitute the file F′ of the digital content purchased.

In a manner independent of the purchase management method, the transaction management server 18 transmits to the payment token distribution center 40 a number of tokens gathered during a predetermined period, comprising in particular the number C₂ of tokens extracted from the electronic purse 38 during the previously described transaction.

In exchange, the payment token distribution centre 40 credits the corresponding amount to a bank account of the transaction management server 18, managed by the financial institution 44. This method of applying value to the payment tokens is conventional and will therefore not be detailed.

It is clearly apparent that the digital content purchase management installation as claimed in the invention facilitates the impulse buying of a digital content, particularly during its broadcast, by permitting the automatic generation of a purchase order from information broadcast with this digital content, the downloading of this purchased digital content being provided for by the download server 20.

It should also be noted that the invention enables the purchase of contents by the unit. For example, it enables the purchase of a single song and not necessarily the whole album containing the broadcast song.

Finally, it will be noted that the invention is not restricted to the abovementioned modes of embodiment.

In effect, as a variant, the files F and F′ are not stored in the same storage means 16. The file F is for example stored in first means for storing digital contents intended for broadcast, these first storage means being accessible by several broadcasting servers such as the server 10. The file F′ is, for its part, stored in second means for storing digital contents intended for downloading, these second storage means being accessible by several download servers such as the server 20.

1. Method for managing purchase of digital contents comprising the steps consisting for a terminal in:
a) receiving a digital content broadcast by broadcasting means;
b) generating a purchase order for said content;
c) transmitting said purchase order to means for processing the order; and
d) downloading said content from said processing means;
the method also comprising, before the download step, a step of payment for said content after which the terminal receives from said processing means a download ticket, said download ticket containing information used by the terminal to download the content in step d),
wherein said download ticket comprises a seed to generate, with the aid of a pseudo-random generator using it as input variable, a pseudo-random key and in that the method also comprises the steps of:
generation by the terminal of said pseudo-random key based on the seed contained in the received download ticket; and of
decipherment, with the aid of the pseudo-random key, of the digital content received in the downloading step d).

2. Method according to claim 1, wherein said download ticket comprises the URL universal address of download means forming part of said processing means.

3. Method according to claim 1, wherein said download ticket is transmitted to said terminal in a form encrypted with the aid of a symmetrical secret key.

4. Method according to claim 1, wherein the payment step is implemented by said terminal communicating with financial transaction management means to which is transmitted said purchase order and which deliver said download ticket received by the terminal.

5. Method according to claim 4, wherein said terminal also receives from said financial transaction management means transaction identifier.

6. Method according to claim 5, wherein the terminal transmits to said download means a proof of payment before step d).

7. Method according to claim 6 wherein the proof of payment contains said transaction identifier received from the financial transaction management means and an authentication message.

8. Method according to claim 1, wherein the download step d) comprises a step of dividing the digital content into a plurality of successive digital sub-contents and of encoding each of these digital sub-contents, followed by a step of downloading these digital sub-contents in succession to said terminal.

9. Method according to claim 8, wherein each encoded digital sub-content, with the exception of the last, comprises the corresponding digital sub-content and the value of a hash function applied to the subsequent encoded digital sub-content.

10. Method according to claim 9, wherein the download step comprises a step of generating a message comprising the number of digital sub-contents and the value of the hash function applied to the first encoded digital sub-content, this message being authenticated with the aid of a symmetrical secret key known only to the order processing means and said terminal.

11. Means for downloading digital contents via a data transmission network, comprising means for receiving a proof of payment of an order to purchase a broadcast digital content, wherein it also comprises means for transmitting this digital content to a terminal sending the proof of payment, said download means being suitable for transmitting the digital content in an encrypted form and also comprising
means for dividing the digital content into a plurality of successive digital sub-contents, means for encoding each of these digital sub-contents and means for successive transmission of these digital sub-contents.

12. Download means according to claim 11, wherein each encoded digital sub-content, with the exception of the last, comprises a corresponding digital sub-content and the value of a hash function applied to the subsequent digital sub-content.

13. Download means according to claim 12, wherein they comprise means for generating a message comprising the number of digital sub-contents and the value of the hash function applied to the first encoded digital sub-content.
